(19) United States
(12) Patent Application Publication
(10) Pub. No.: US 2022/0056587 A1
(43) Pub. Date: Feb. 24, 2022

(54) METHOD OF FABRICATING AND COATING COPPER NANOWIRES

(71) Applicant: Portland State University, Portland, OR (US)

(72) Inventors: Suhyun Lee, Portland, OR (US); Suming Wang, Suzhou (CN); Sung Yi, Happy Valley, OR (US)

(21) Appl. No.: 17/444,878

(22) Filed: Aug. 11, 2021

Related U.S. Application Data
(60) Provisional application No. 63/069,560, filed on Aug. 24, 2020.

(51) Int. Cl. C23C 18/16

(52) U.S. Cl. CPC C23C 18/1637; C23C 18/1651; H01B 5/02; C23C 18/168; C23C 18/166; C23C 18/1666

(57) ABSTRACT

An environmentally friendly method of coating copper nanowires to reduce oxidation and/or increase electrical/thermal conductivity of the copper nanowires. In one embodiment, a method for coating copper nanowires includes preparing a first solution including a dipolar aprotic organic compound, adding copper nanowires to the first solution under stirring while maintaining the first solution at a pre-determined temperature, preparing a second solution including an oxidation resistant metal, coating the copper nanowires in the oxidation resistant metal by adding the second solution to the first solution under stirring and while maintaining the first solution at the pre-determined temperature.

### CROSS REFERENCE TO RELATED APPLICATIONS

The present application claims priority to U.S. Provisional Patent Application No. 63/069,560, entitled “METHOD OF FABRICATING AND COATING COPPER NANOWIRES”, filed on Aug. 24, 2020. The entire contents of the above-listed application are hereby incorporated by reference for all purposes.

### FIELD

The present description relates to methods of fabricating and coating copper nanowires. More particularly, the present description is directed to methods of fabricating copper nanowires and coating copper nanowires with conductive and oxidation resistant metals via an electroless reaction.

### BACKGROUND

Multifunctional nanomaterials combining high transparency and conductivity are of interest for a variety of technological applications. For example, indium tin oxide (ITO) is a conductive material widely used for fabricating transparent conductive materials which can be used in electronics such as flat panel displays, touch screens, and solar cells. However, due to the brittleness of ITO, its use in flexible electronics (e.g., foldable/bendable devices such as foldable tablets and phones, bendable photovoltaic cells, bendable light emitting diodes, and wearable sensors) is precluded. Further, the high demand for ITO has driven the price up substantially, making the use of ITO cost ineffective for many products. In order to overcome the shortcomings of ITO, alternative metal nanowires, including copper, silver, and gold nanowires, are being developed as substitutes.

Copper nanowires in particular show promise as a highly flexible and low cost conductive material as copper has the second highest electrical conductivity and lowest resistivity in metal materials and is thousands of times more abundant and hundreds of times less expensive than silver or gold. Because of its high electrical conductivity, flexibility, and low cost, copper nanowires are being used in conductive ink, transparent conductive films, and wearable sensors. However, copper nanowires are vulnerable to oxidation, which may cause significant degradation in its electrical and thermal conductivity.

One approach to mitigate copper nanowire oxidation involves coating the copper nanowires in an oxidation resistant material, thereby insulating the copper from contact with oxygen and slowing or preventing oxidation of the underlying copper. However, current coating procedures for copper nanowires rely on the use of toxic chemicals, such as ammonia. Therefore, it is generally desired to explore methods of coating copper nanowires which bypass the use of toxic or environmentally unfriendly reagents such as ammonia.

### SUMMARY

The current disclosure may at least partially address the above indicated issues by providing methods for coating copper nanowires in oxidation resistant metals via an electroless reaction which employs environmentally benign reagents. In one example, the current disclosure provides a method comprising (a) preparing a first solution including a dipolar aprotic organic compound, (b) adding copper nanowires to the first solution under stirring while maintaining the first solution at a pre-determined temperature, (c) preparing a second solution comprising an aqueous solution of an oxidation resistant metal, (d) coating the copper nanowires in the oxidation resistant metal by adding the second solution prepared in step (c) to the first solution prepared in step (a) under stirring and while maintaining the first solution at the pre-determined temperature.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIGS. 1A and 1B show scanning electron microscopy (SEM) images of copper nanowires at a first and second magnification respectively;

FIGS. 2A and 2B shows SEM images of silver coated copper nanowires;

FIG. 3 shows a transmission electron microscopy (TEM) image of silver coated copper nanowires; and

FIG. 4 shows a TEM image of copper nanowires.

### DETAILED DESCRIPTION

Unless defined otherwise, all technical and scientific terms used herein have the same meaning as commonly understood by one of ordinary skill in the art to which the present invention pertains.

Metallic nanowires are multifunctional materials with good thermal and electrical conductivity, high aspect ratio and optical transparency. Their properties make them useful in a variety of fields including electronics, imaging, and solar cells. The current disclosure relates to methods of coating copper nanowires in conductive and oxidation resistant metals by an electroless, solution-based method using an environmentally benign copper surfactant and oxidation resistant metal reductant. While any copper nanowires may be used, in some aspects the copper nanowires may be prepared using ethylenediamine and hydrazine as a capping agent and reducing agent. As described in further detail below, the shape and dimensions of the copper nanowires may be controlled through the fabrication process.

Copper nanowires have a combination of high performance, high availability, and low cost with electrical resistivity of 1.673 μΩ·cm at 20° C. However, once copper nanowires are exposed to ambient conditions, oxidation significantly decreases the electrical conductivity. While this oxidation may be inhibited through the use of an oxidation-resistant metallic shell, current methods, such as the methods disclosed in WO 2015194850 and Luo, Xiaoxiong, et al. “Silver-coated copper nanowires with improved anti-oxidation property as conductive fillers in low-density polyethylene.” The Canadian Journal of Chemical Engineering 91.4 (2013): 630-637, employ ammonia as a pre-treatment reagent for silver. Ammonia is a corrosive material, and exposure to concentrated ammonia may have adverse effects on health, including burning the skin, eye damage, and irritation of the respiratory system. Therefore, it is generally desirable to explore methods of coating copper with silver or other oxidation resistant and conductive materials which do not rely on the use of toxic reagents.

Surprisingly, the inventors herein discovered that copper nanowires may be coated with oxidation resistant and conductive metals via an electroless reaction which bypasses the use of ammonia or other toxic reagents. In particular, the inventors herein discovered that dipolar aprotic organic compounds may act as a copper surfactant and shell-metal reductant. In some embodiments the sulfur containing surfactant may be a food grade reagent safe for human consumption.

In one example, the current disclosure provides a method for coating copper nanowires including preparing a first solution including a dipolar aprotic organic compound, adding copper nanowires to the first solution under stirring while maintaining the first solution at a pre-determined temperature, preparing a second solution including an aqueous solution of an oxidation resistant metal, coating the copper nanowires in the oxidation resistant metal by adding the second solution to the first solution under stirring and while maintaining the first solution at the pre-determined temperature.

In another aspect, the current disclosure provides a method for coating copper nanowires in silver by preparing a first solution including a food grade dipolar aprotic organic compound, adding copper nanowires to the first solution under stirring while maintaining the first solution at a pre-determined temperature, preparing an aqueous solution of silver, and coating the copper nanowires in silver by adding the aqueous solution of silver to the first solution under stirring and while maintaining the first solution at the pre-determined temperature.

Dipolar aprotic solvents contemplated herein include, but are not limited to, sulfones, sulfoxides, sulfides, sulfates, and sulfonates, and further include dimethylformamide, gamma-butyrolacetone, N-methyl-2-pyrrolidone, and dimethylacetamide. Sulfones contemplated herein include but are not limited to methyl sulfonylmethane (DMSO₂), methylvinylsulfone, ethylmethylsulfone, 2-aminoethylmethylsulfone hydrochloride, butadiene sulfone, divinylsulfone, ethylvinylsulfone, methanesulfonylacetone, 2,2′-sulfonyldiethanol, and S-propyl ethanethioate. Sulfoxides contemplated herein include, but are not limited to dimethylsulfoxide (DMSO). Sulfides contemplated herein include, but are not limited to, dimethyl sulfide. Sulfates contemplated herein, include but are not limited to, dimethyl sulfate. Sulfonates contemplated herein include but are not limited to, sodium dodecyl benzenesulfonate (SDBS).

Exemplary food grade or otherwise environmentally friendly dipolar aprotic solvents include, but are not limited to, DMSO₂, DMSO, ethyl methyl sulfone, 2-aminoethylmethylsulfone hydrochloride, divinyl sulfone, ethyl vinyl sulfone, methanesulfonylacetone and other food grade and/or non-corrosive or non-toxic sulfones, sulfoxides, and sulfonates.

In some embodiments, sufficient dipolar aprotic organic compound is added to the first solution to produce a 0.01 wt % to 5.0 wt % solution, with respect to the dipolar aprotic organic compound. In some embodiments, the solvent of the first solution used to dissolve the dipolar aprotic organic compound is a material such as, but not limited to, water, distilled water, deionized water, ethanol, isopropyl alcohol, methanol or dimethyl sulfoxide.

Oxidation resistant metals with standard reduction potentials greater than the standard reduction potential of copper may be used in conjunction with the methods disclosed herein to coat copper nanowires in a protective yet conductive shell, thereby inhibiting oxidation of the underlying copper. Metals having standard reduction potentials greater than the standard reduction potential of copper(II) are suitable for use with the herein disclosed methods, as such oxidation resistant metals spontaneously replace exposed copper atoms on solvent exposed surfaces of copper nanowires.

Exemplary oxidation resistant metals which may be used to coat copper nanowires include, but are not limited to, silver (Ag), gold (Au), platinum (Pt), and nickel (Ni). In some embodiments, soluble inorganic salts of silver, gold, platinum and nickel may be used to produce aqueous solutions of oxidation resistant metal ions, which may be used according to the methods disclosed herein to coat copper nanowires. In one embodiment, an aqueous solution of silver may be produced by dissolving in water or other suitable polar solvent one or more of the compounds selected from silver nitrate, silver sulfate, silver acetate, silver chloride, silver chlorate, silver bromide, silver iodide, or silver nitrate. In some embodiments, the aqueous solution of oxidation resistant metal may be of a concentration from 0.0001 to 0.1 M, or any fractional amount therebetween. The inventors herein discovered that when less than 0.0001 M of oxidation resistant metal is added, incomplete coating of the copper nanowires occurs, whereas when more than 0.1 M of oxidation resistant metal is added, nanoparticles of the oxidation resistant metal precipitate and poor coating of the copper nanowires is observed.

In some embodiments, the above disclosed reactions occur within a pre-determined temperature range of 20° C. to100° C., or any fractional amount therebetween. When the reaction temperature is more than 100° C., there is a possibility that the aqueous solution evaporates or copper products will oxidize.

In another aspect, the current disclosure provides a method for synthesizing copper nanowires coated by an oxidation resistant metal comprising, stirring an aqueous solution comprising sodium hydroxide, copper compound, ethylenediamine (EDA), and hydrazine (N₂H₄) at a temperature between 20° C. and 100° C., or any fractional temperature therebetween, and maintaining the solution for a pre-determined duration of time to grow copper nanowires, preparing a methylsulfonylmethane (DMSO₂) solution with ultrasonic stirring at a temperature between 20° C. and 100° C., or any fractional temperature therebetween, adding the copper nanowires to the DMSO₂ solution under ultrasonic stirring and while maintaining the solution at a temperature between 20° C. and 100° C., preparing an aqueous solution of silver by dissolving a silver compound in water, and coating the copper nanowires in silver by adding the aqueous solution of silver to the DMSO₂ solution including the copper nanowires under ultrasonic stirring and while maintaining the DMSO₂ solution at a temperature between 20° C. and 100° C. While the pre-determined stirring time may be calculated by those of skill in the art based on a number of factors including temperature and concentration, in some aspects, the aqueous solution is stirred from 1 to 3 hours.

Copper compounds which may act as sources of copper ions include, but are not limited to, soluble inorganic copper salts, such as copper chloride, copper chlorate, copper nitrate, copper sulfate, copper acetate, copper bromide, copper iodide, copper phosphate or copper carbonate. In one embodiment, the copper compound used as a source of copper for copper nanowire formation is copper chloride, as copper chloride is highly soluble in polar solvents, wherein it readily dissociates to form copper(II) ions in solution.

In some embodiments, the copper compound may be added to the aqueous solution to produce a copper(II) concentration of 0.01 M to 1.0 M, or any fractional amount therebetween. The inventors herein discovered that use of greater than 1.0 M copper(II) results in aggregation of copper nanoparticles, as opposed to formation of copper nanowires, while use of less than 0.01 M copper(II) ion resulted in slow formation of copper nanowires and an overall smaller yield.

In some embodiments, during formation of copper nanowires, sodium hydroxide is added to the aqueous solution until a concentration of 4.5 M to 15 M, or any fractional amount therebetween, is reached. The sodium hydroxide plays a role in generating copper hydroxide precipitates by keeping the reaction solution alkaline. The inventors herein have discovered that when 5-15 M of sodium hydroxide is used, the desired copper nanowires are formed. When less than 5 M of sodium hydroxide is used, copper ions cannot be reduced properly because of a lack of hydroxide, whereas when more than 15 M of sodium hydroxide is used, it is difficult dissolve additional reagents in the reaction solution as it approaches saturation with NaOH.

In some embodiments, the concentration of EDA may be 0.05 M-1.0 M, or any fractional amount therebetween. The inventors herein discovered that when less than 0.05 M of EDA is used, tapered copper nanowires are formed with aggregation of copper seeds. Whereas when more than 1.0 M of EDA is used, the resulting copper nanowires have irregular surfaces.

In one embodiment, hydrazine (N₂H₄) is employed as a reducing agent in the synthesis of copper nanowires, wherein the concentration of N₂H₄ is 0.001 M to 1.0 M, or any fractional amount therebetween. The inventors herein have discovered that when more 1.0 M of N₂H₄ is added, thicker and shorter copper nanowires are formed, in some cases copper nanoparticles dominated without the formation of copper nanowires.

In some embodiments, the above disclosed reactions occur within a pre-determined temperature range of 20° C. to100° C., or any fractional amount therebetween. The inventors herein have discovered that when the reaction temperature is less than 20° C., copper nanowires are improperly formed accompanied by aggregation of copper seeds and irregular surfaces.

In some embodiments, following formation of copper nanowires, the copper nanowires are washed and dispersed in the solution containing the dipolar aprotic organic compound to remove the impurities on the surface thereof including EDA and N₂H₄. In order to disperse copper nanowires in the solution containing the dipolar aprotic organic compound, copper nanowires are added to the solution containing the dipolar aprotic organic compound until the solution is 0.01 to 0.03 weight % of copper nanowires. By adding copper nanowires into the solution containing the dipolar aprotic organic compound, the copper at the surface of the copper nanowires are oxidized into their ionic state, while the dipolar aprotic organic compound protects the copper nanowire surface from reacting with other reagents. The ionic state of the copper surface is able to accommodate silver coating, and upon introduction of silver ions into the reaction solution, the dipolar aprotic organic compound facilitates a redox reaction between the copper and silver, enabling the silver to coat the surface of the copper nanowires. As described in the Examples, the copper nanowires are coated in conductive and oxidation resistant metals by an electroless solution-based method using an environmentally benign dipolar aprotic organic compound. It is to be understood that this invention is not limited to the particular formulations, process steps, and materials disclosed herein as such formulations, process steps, and materials may vary somewhat. It is to be understood that the terminology employed herein is used for the purpose of describing particular embodiments only and not to limit the scope of the invention.

### EXAMPLE 1

### Preparation of Copper Nanowires with Various Concentrations of NaOH

Copper nanowires were synthesized using a solution reaction approach. Various concentrations of sodium hydroxide (NaOH) were employed to promote copper ion precipitation to copper hydroxide (Cu(OH)₂). Copper chloride (CuCl₂) was utilized as the copper precursor. Copper precursors other than copper organometallics are suitable for the solution-based method. Ethylenediamine (EDA, C₂H₈N₂, 99.5%) was used as a capping agent to prevent copper seeds from aggregating. Hydrazine (N₂H₄, 35 wt %) was used as the reducing agent, which is generally responsible for reducing copper ions to copper atoms. Deionized water (DI H₂O) was used as a solvent to dissolve NaOH.

All of the steps of Example 1 were carried out under 300 rpm magnetic stirring to homogenize the reaction solution. In addition a water-bath was used to maintain the reaction solution temperature within a pre-determined range during the 2 hour reaction time.

In order to evaluate the effect of NaOH on the formation of copper nanowires, various amounts of NaOH (1.024 g, 1.44 g, 1.85 g, 2.56 g, and 2.94 g) were dissolved in 5 ml of DI H₂O to produce NaOH solutions of 5M, 7M, 9M, 12M, and 14.8M, respectively. The NaOH solutions were submerged in a temperature controlled water-bath to maintain the temperature of the reaction solutions between 20° C. to 100° C. After dissolution of the NaOH in the DI H₂O (approximately 10 mins, indicated by reaction solution becoming colorless), EDA (50 μl) was then added to each of the NaOH solutions and stirred until the solutions became colorless. After 2 mins, CuCl₂ (4.6 mg) dissolved in 2 ml of DI H₂O and was added to each reaction solution and stirred for 10 mins. Upon addition of the CuCl₂ aqueous solution, the reaction solutions became light blue, turning dark blue after 10 mins. CuCl₂ can easily aggregate in solution, however, EDA acts to prevent copper from aggregating. The following chemical equation describes the reaction occurring following addition of the CuCl₂ to the reaction solutions:

2NaOH(aq)+CuCl₂→Cu(OH)₂+2NaCl Equation 1

As shown in chemical equation 1, copper hydroxide Cu(OH)₂ forms following addition of the CuCl₂ to the reaction solution. The EDA surrounds the surface of the Cu(OH)₂, stabilizing it and preventing aggregation. Prior to N₂H₄ addition to each reaction solution, N₂H₄ (1 ml) was diluted in 3 ml of DI H₂O to produce diluted N₂H₄. The diluted N₂H₄ was added to each reaction solution to reach a N₂H₄ concentration of 0.0157 M within the reaction solution, and the following chemical equation 2 and chemical equation 3 occurred thereafter:

Cu(OH)₂+N₂H₄→2Cu₂O+N₂+H₂O Equation 2.

2Cu₂O+N₂H₄→4Cu+2H₂O+N₂ Equation 3.

As shown in chemical equation 2 and chemical equation 3, Cu(OH)₂ was reduced to copper oxide (Cu₂O) particles by action of the reducing agent N₂H₄. With continuous heating provided by the water-bath, the Cu₂O was further reduced by N₂H₄ to atomic copper, which grows the copper nanowires. The color of the reaction solution changed from dark blue to reddish brown during the 2 hour reaction time. Finally, the copper nanowires were washed with methanol to remove the reaction solution. The effect of NaOH concentration on the dimension of copper nanowires produced according to the above protocol is summarized in Table 1 below.

TABLE 1
The effect of sodium hydroxide on the dimensions of copper
nanowires

| Sodium hydroxide (M) | Length (μum) | Diameter (nm) |
|---|---|---|
| 5 | longer than 3 | 130-250 |
| 7 | longer than 12 | 80-160 |
| 9 | longer than 18 | 25-45 |
| 12 | longer than 12 | 100-500 |
| 14.8 | longer than 2 | 210-270 |

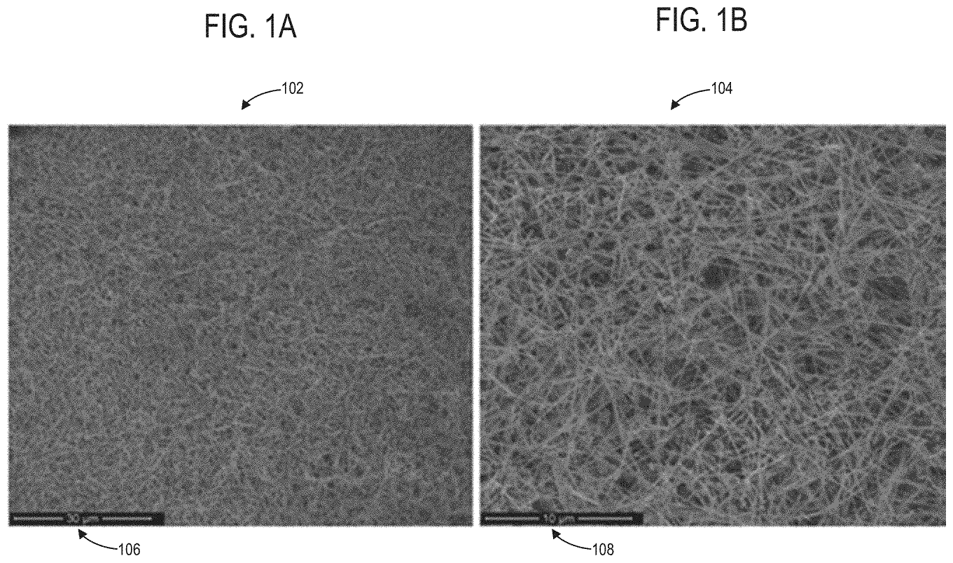

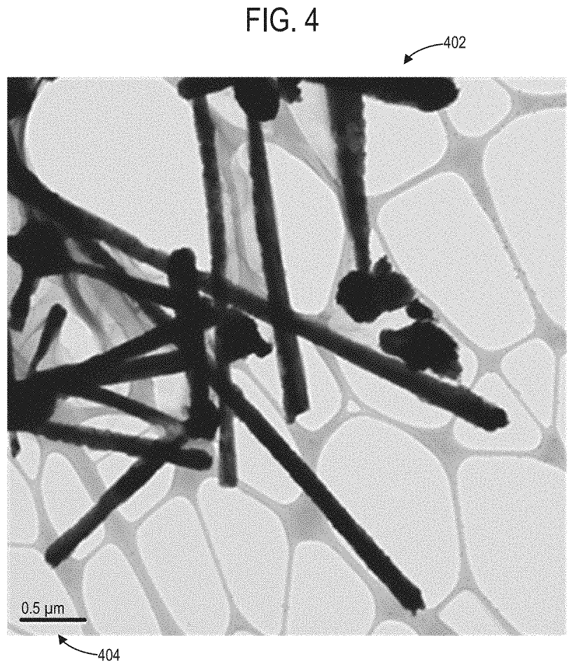

FIGS. 1A and 1B show SEM images of uncoated copper nanowires fabricated according the above protocol using 9M NaOH, 50 μl EDA, 4.6 mg CuCl₂, and 15 μl N₂H₄. FIG. 1A shows view 102 wherein the copper nanowires are captured at a first magnification indicated by scale bar 106, showing a reference length of 30 μm. FIG. 1B shows view 104, wherein the copper nanowires are captured at a second, greater magnification, indicated by scale bar 108 showing a reference length of 10 μm. As can be seen, the copper nanowires produced are well dispersed, and elongate, forming a sheet with a high degree of interconnections between the copper nanowires, and with substantial uniformity in aspect ratio of the copper nanowires. Similarly, FIG. 4 shows a TEM image of uncoated copper nanowires fabricated according to the above protocol. FIG. 4 shows view 402, wherein copper nanowires are captured at a magnification indicated by scale bar 404, showing a reference length of 0.5 μm.

Although specific examples of copper nanowire preparation methods are included herein, it will be appreciated that the disclosed methods of copper nanowire coating are compatible with copper nanowires prepared via other methods known in the art.

### EXAMPLE 2

### Preparation of Copper Nanowires with Various Concentrations of EDA

The effect of EDA concentration on copper nanowire dimensions was investigated using the approach discussed in Example 1 above, with a concentration of NaOH of 14.8M, CuCl₂ of 4.6 mg, and with various concentrations of EDA (8.06 mM, 16.1, 26.9 mM, and 32.2 mM). The effect of EDA concentration on the dimension of copper nanowires produced according to the above protocol is summarized in Table 2 below.

TABLE 2
The effect of EDA on the dimensions of copper nanowires

| Capping agent (EDA, mM) | Length (μm) | Diameter (nm) |
|---|---|---|
| 8.06 | longer than 4 | 150-220 |
| 26.9 | longer than 2 | 210-270 |
| 32.2 | longer than 6 | 130-170 |

### EXAMPLE 3

### Preparation of Copper Nanowires with Various Concentrations of CuCl₂

The effect of CuCl₂ concentration on copper nanowire dimensions was investigated using the approach discussed in example 1 above, with a concentration of NaOH of 9M, 50 μl EDA, and various concentrations of CuCl₂ (0.0171 M, 0.0372 M). The effect of CuCl₂ concentration on the dimension of copper nanowires produced according to the above protocol is summarized in Table 3 below.

TABLE 3
The effect of copper chloride on the dimensions of
copper nanowires

| Copper chloride (M) | Length (μm) | Diameter (nm) |
|---|---|---|
| 0.0171M | longer than 6 | 100-240 |

| | |
|---|---|
| 0.0372M | Needed to increase the amount of |
| | EDA at the same time |

### EXAMPLE 4

### Preparation of Copper Nanowires with Various Concentrations of N₂H₄

The effect of N₂H₄ concentration on copper nanowire dimensions was investigated using the approach discussed in example 1 above, with a concentration of NaOH of 14.8 M, 50 μl EDA, and with various concentrations of N₂H₄ (0.00171 M, 0.0157 M). The effect of N₂H₄ concentration on the dimension of copper nanowires produced according to the above protocol is summarized in Table 4 below.

TABLE 4
The effect of reducing agent on the dimensions of
copper nanowires

| Reducing agent | | |
|---|---|---|
| (N₂H₄, M) | Length (μm) | Diameter (nm) |
| 0.00171 | 4-13 | 250-550 |
| 0.0157 | longer than 18 | 25-45 |

### EXAMPLE 5

### Preparation of Copper Nanowires at Various Temperatures

The effect of temperature on copper nanowire dimensions was investigated using the approach discussed in Example 1 above, with a concentration of NaOH of 14.8 M, EDA of 30 μl, CuCl₂ of 4.6 mg, and various reaction temperatures maintained via water-bath (40° C., 50° C., 60° C., 70° C., 90° C., 100° C.). The effect of N₂H₄ concentration on the dimension of copper nanowires produced according to the above protocol is summarized in Table 5 below.

TABLE 5
The effect of reaction temperature on the dimensions of
copper nanowires

| Reaction | | |
|---|---|---|
| temperature (°C.) | Length (μm) | Diameter (nm) |
| 40 | longer than 3.5 | 130-250 |
| 50 | longer than 5 | 130-280 |
| 60 | longer than 8 | 200-310 |
| 70 | longer than 5 | 210-260 |
| 80 | longer than 6 | 120-280 |

| | |
|---|---|
| 90 | The oxidation of copper nanowires |

### EXAMPLE 6

### Coating of Copper Nanowires in Silver

In order to fabricate core-shell (Cu—Ag) nanowires, silver nitrate (AgNO₃) was utilized as a shell material to coat the surface of pre-synthesized copper nanowires prepared as described above with a concentration of NaOH of 9M, EDA of 50 μl, and CuCl₂ of 4.6 mg. Deionized water (DI H₂O) was employed as solvent to dissolve silver salt. In addition, methylsulfonylmethane (DMSO₂) was used as copper surfactant and silver reducing agent.

Coating of the copper nanowires in silver was accomplished by addition of DMSO₂ and silver solution at room temperature without electrodes or heating. First, a silver solution was prepared by dissolving 0.3 mg of AgNO₃ in 2 ml of DI H₂O. Then, 200 μl of the silver solution was added drop-wise into a 1 wt % solution of DMSO₂ containing well-dispersed copper nanowires. After adding the silver solution, the DMSO₂ solution color changed from reddish brown to dark grey, indicating that the coating process had started. The DMSO₂ solution containing the silver solution and copper nanowires was ultrasonicated for 10 mins following addition of the silver solution.

Silver coating of the copper nanowires was induced via an oxidation-reduction reaction between copper and silver according to the following chemical equations 4, 5, and 6:

Cu→Cu²⁺+2e⁻:E⁰=−0.3419V Equation 4

Ag⁺+e⁻→Ag:E⁰= 0.7996V Equation 5

Cu+2Ag⁺→Cu²⁺+2Ag↓:ΔE⁰=+0.4577V Equation 6

The reaction between copper and silver occurs spontaneously because the difference of redox potential (ΔE⁰) is positive (+0.4577V) as shown in chemical equation 6. Silver has higher reduction potential than copper, therefore, silver ions can be reduced to silver atoms in the presence of atomic copper.

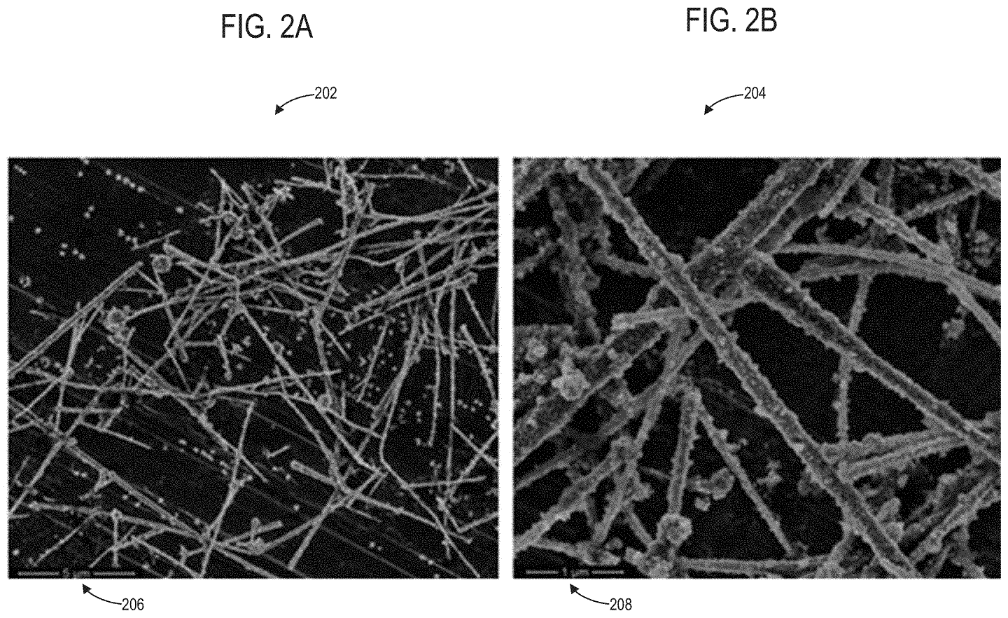

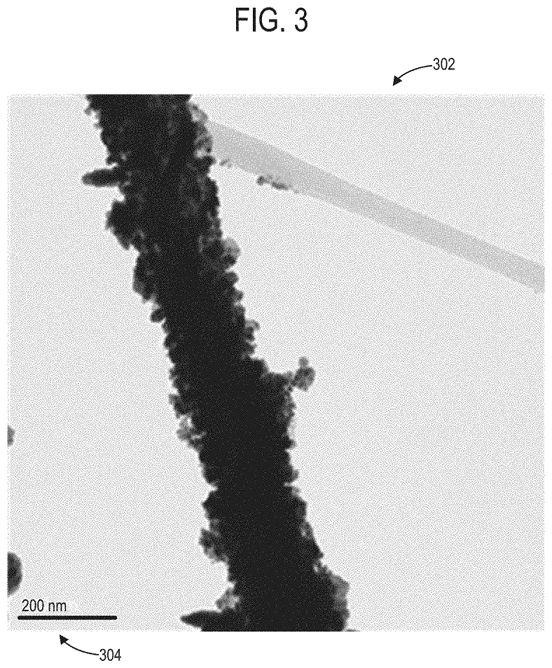

FIGS. 2A and 2B show SEM images of copper nanowires after coating with silver according to the above example. View 202 of FIG. 2A shows the silver coated copper nanowires at a first magnification, indicated by reference bar 206 showing a length of 5 μm. View 204 of FIG. 2B shows the silver coated copper nanowires at a second, greater magnification, indicated by reference bar 208 showing a length of 1 μm. As can be seen in FIGS. 2A and 2B, the Cu—Ag nanowires display lengths longer than 15 μm. Compared with FIGS. 1A and 1B, which show uncoated copper nanowires, the surface of copper nanowires in FIGS. 2A and 2B is rough because of the formation of the silver shell (the roughness is well displayed in view 204). The surface of the Cu—Ag nanowires and morphology are more clearly shown by the TEM image 302 of FIG. 3. As shown in FIG. 3, the copper nanowires are well covered by the silver shell, and the diameter of copper nanowires and thickness of silver shell, which may be determined by comparing the coated copper nanowire diameter against reference bar 304, showing a length of 200 nm, are approximately 90 nm and 12 nm, respectively.

One skilled in the art will readily appreciate that the present invention is well adapted to carry out the objects and obtain the ends and advantages mentioned, as well as those inherent therein. The present examples along with the methods, procedures, treatments, molecules, and specific compounds described herein are representative of embodiments, are exemplary, and are not intended as limitations on the scope of the invention. Changes therein and other uses will occur to those skilled in the art which are encompassed within the spirit of the invention as defined by the scope of the claims.

1. A method comprising:
(a) preparing a first solution including a dipolar aprotic organic compound;
(b) adding copper nanowires to the first solution under stirring while maintaining the first solution at a pre-determined temperature;
(c) preparing a second solution comprising an aqueous solution of an oxidation resistant metal;
(d) coating the copper nanowires in the oxidation resistant metal by adding the second solution prepared in step (c) to the first solution prepared in step (a) under stirring and while maintaining the first solution at the pre-determined temperature.

2. The method of claim 1, wherein the dipolar aprotic organic compound is selected from the group consisting of methylsulfonylmethane (DMSO₂), dimethylsulfoxide (DMSO), dimethylformamide, gamma-butyrolacetone, N-methyl-2-pyrrolidone, and dimethylacetamide.

3. The method of claim 1, wherein the oxidation resistant metal is selected from the group consisting of silver, gold, platinum, and nickel.

4. The method of claim 1, wherein the copper nanowires of step (b) are produced by stirring an aqueous solution comprising sodium hydroxide, copper compound, ethylenediamine (EDA), and hydrazine (N₂H₄) at a temperature between 20° C. and 100° C. and maintaining the aqueous solution for a pre-determined duration of time to grow the copper nanowires.

5. A method comprising:
(a) preparing a first solution including a food grade dipolar aprotic organic compound;
(b) adding copper nanowires to the first solution under stirring while maintaining the first solution at a pre-determined temperature;
(c) preparing an aqueous solution of silver; and
(d) coating the copper nanowires in silver by adding the aqueous solution of silver prepared in step (c) to the first solution prepared in step (a) under stirring while maintaining the first solution at the pre-determined temperature.

6. The method of claim 5, wherein the food grade dipolar aprotic organic compound is selected from the group consisting of methylsulfonylmethane (DMSO₂), dimethylsulfoxide (DMSO), and sodium dodecyl benzenesulfonate (SDBS).

7. The method of claim 5, wherein step (d) includes coating the copper nanowires in silver for a duration of time sufficient to produce a shell with a thickness in the range of 5 nm to 15 nm, and any fractional amount therebetween.

8. The method of claim 5, wherein step (b) includes adding 0.01 to 0.03 parts by weight of the copper nanowires to the first solution for every 100 parts by weight of the first solution.

9. A method for electroless coating of copper nanowires comprising:
(a) stirring an aqueous solution comprising sodium hydroxide, copper compound, ethylenediamine (EDA), and hydrazine (N₂H₄) at a temperature between 20° C. and 100° C. and maintaining the solution for a pre-determined duration of time to grow copper nanowires;
(b) preparing a methylsulfonylmethane (DMSO₂) solution with ultrasonic stirring at a temperature between 20° C. and 100° C.;
(c) adding the copper nanowires prepared in step (a) to the DMSO₂ solution prepared in step (b) under ultrasonic stirring and while maintaining the solution at the temperature between 20° C. and 100° C.;
(d) preparing an aqueous solution of silver by dissolving a silver compound in water; and
(e) coating the copper nanowires in silver by adding the aqueous solution of silver prepared in step (d) to the DMSO₂ solution including the copper nanowires prepared in step (c), under ultrasonic stirring and while maintaining the DMSO₂ solution at the temperature between 20° C. and 100° C.

10. The method of claim 9, wherein the sodium hydroxide in step (a) is at a concentration between 4.5 M and 15 M.

11. The method of claim 9, wherein the EDA in step (a) is at a concentration between 0.05 M and 1.0 M.

12. The method of claim 9, wherein the copper compound in step (a) is selected from the group consisting of copper chloride, copper nitrate, copper sulfate, copper chlorate, copper acetate, copper bromide, copper iodide, copper phosphate or copper carbonate.

13. The method of claim 9, wherein the copper compound in step (a) is at a concentration between 0.01 M and 1.0 M.

14. The method of claim 9, wherein the N₂H₄ in step (a) is at a concentration between 0.001 M and 1.0 M.

15. The method of claim 9, wherein the DMSO₂ in step (b) is dissolved in methanol at a concentration between 0.01 weight percent and 5.0 weight percent, under ultrasonic stirring.

16. The method of claim 9, wherein step (c) further includes washing and dispersing the copper nanowires in the DMSO₂ solution of step (b).

17. The method of claim 9, wherein step (c) includes adding 0.01 to 0.03 parts by weight of the copper nanowires to the DMSO₂ solution for every 100 parts by weight of the DMSO₂ solution.

18. The method of claim 9, wherein the silver compound in the step (d) is selected from the group consisting of silver nitrate, silver chlorate, and silver acetate.

19. The method of claim 9, wherein the silver compound in step (d) is at a concentration between 0.0001 M and 1.0 M.

20. The method of claim 9, wherein steps (a), (b), (c), (d), and (e) are carried out at a temperature between 20° C. and 100° C.
